(19) United States
(12) Patent Application Publication
(10) Pub. No.: US 2008/0207035 A1
(43) Pub. Date: Aug. 28, 2008

(54) Contacting Device for a Flexible Ribbon Conductor

(75) Inventor: Michael Jahn, Hoyerswerda (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/556,574

(22) PCT Filed: Feb. 10, 2004
(86) PCT No.: PCT/DE04/00227

§ 371 Date: Feb. 14, 2008

(30) Foreign Application Priority Data
May 12, 2003 (DE) 103211845

(51) Int. Cl. H01R 12/12

(52) U.S. Cl. 439/329

(57) ABSTRACT

A contacting device (1) particularly suited to contacting a flexible flat conductor (2) to a circuit board (3). The device has at least one contacting element (4), which is attached with an attachment end (10) to the circuit board (3), and which is in contact with a terminal end (14) in a neutral position and under pre-tension with the circuit board (3), as well as with a handling element (5), which can be used to reversibly pull out the terminal end (14) of the contacting element, or each contacting element (4) from the neutral position into the opened position, in which the terminal end, or each terminal end (14) is positioned at a sufficient distance from the circuit board (3) to enable the flat conductor (2) to be inserted without applying pressure.

### BACKGROUND OF THE INVENTION

The invention relates to a contacting device for contacting a flexible flat conductor to a circuit board.

Prefabricated flat conductors, particularly so-called “foil conductors”, are frequently used today instead of standard conducting wires for the electrical cabling of machines. Flat conductors are used in particular in the automobile industry as components of on-board networks. In particular, two different types of flat conductors are common. With so-called “foil-insulated” flat conductors (FFC), metal bands or wires are embedded into a foil-type insulating material. Alternatively, so-called “foil printed” switches (FPC) are used, for which the conducting strips are pressed or sprayed onto a base foil.

In order to create an electrical contact between a flat conductor and a circuit board, the end of the flat conductor is usually fitted with a pin-and-socket connector, the corresponding counterpiece of which is attached to the circuit board. The mechanical and electrical connection between the flat conductor and the pin-and-socket connector is usually created by soldering and/or crimping, and is therefore comparatively costly. It would be desirable to have a contacting device which enables the flat conductor to be contacted directly, in a similar manner as is common when contacting simple conducting wires. The contacting device should ensure a safe, indestructible mechanical support for the flat conductor. It should also be possible to detach the flat conductor as required from the contacting device without damaging or destroying it.

### BRIEF DESCRIPTION OF THE DRAWINGS

The object of the invention, in relation to the requirements described above, is to provide an improved contacting device for contacting a flexible flat conductor to a circuit board.

This object is realised according to the invention by a contacting device having the features described below. The contacting device includes at least one contacting element, which is attached to the circuit board using an attachment end piece. The contacting element, or each contacting element, is fitted with a terminal end, which is in contact with the circuit board under pre-tension in a neutral position. A handling element is also provided, which can be used to pull the terminal end of the contacting element, or each contacting element from the neutral position into an opened position. The opened position is characterised therein that the terminal end, or each terminal end of the circuit board is at a sufficient distance to be able to guide the end of a flat conductor to be contacted between the terminal end or each terminal end on the one hand, and the circuit board on the other, without applying pressure. Here, the effect of the handling element on the contacting element is reversible. This means that when the handling element is actuated, the terminal end of the contacting element, or each contacting element, can be moved back from the opened position into the neutral position. A flat conductor which is inserted between at least one terminal end and the circuit board is thereby jammed between the terminal end, or each terminal end, and is thus in contact with the circuit board.

The contacting device according to the invention enables the flat conductor to contact the circuit board directly, without first requiring a pin-and-socket connector to be connected to the flat conductor. The contact is made via a simple terminal connection. Work-intensive mounting procedures, such as soldering or crimping, are not required for the flat conductor contact. At the same time, a good electrical contact, which has long-term stability, is secured between the flat conductor and the circuit board.

In order to mount the contacting device easily, and to provide a stable seat for the contacting element, the attachment end of the contacting element, or each contacting element, is preferably pressed into the circuit board. Alternatively, however, the attachment end of the contacting element, or each contacting element can be soldered to the circuit board. For practical purposes, given that a flat conductor usually contains several conducting strips, several contacting elements, specifically a number of contacting elements adapted to the number of conducting strips, is provided, the terminal ends of which can be simultaneously pulled out using the handling element.

In the preferred embodiment, the contacting element, or each contacting element, takes the form of a band or rod, and has a hook-like bent shape. Accordingly, a bow segment is connected to an area of the contacting element which supports the attachment end, to which in turn an area supporting the terminal end is connected. The attachment end is preferably aligned approximately vertically to the level of the circuit board, while the area supporting the terminal end is in turn bent diagonally onto the circuit board. For practical purposes, the terminal end has a convex curve, in order to avoid sharp edges in the terminal area.

In a particularly advantageous embodiment, the handling element comprises an axis which is parallel to the circuit board, and which can be rotated, from which at least one lever arm protrudes in an approximately radial direction. Here, the bow segment of the contacting element, or of each contacting element, is led particularly closely around the circumference of the axis, so that the contacting element, or each contacting element, encompasses the axle in a clasp-like manner. The contacting element, or each contacting element, is pulled out in a particularly simple manner in terms of its construction using an eccentric projection, which is fitted to the axis at least at the axial height of each contacting element. This eccentric projection is pushed against the contacting element or each contacting element when the handling element is swung from being closed to being opened. In so doing, the eccentric projection bends the contacting element in such a way that the terminal end of the contacting element is pulled from the neutral position into the opened position. When the handling element is closed, the eccentric projection is in contrast twisted out of the bearing area of the contacting element with the axis, i.e. out of the angle area in which the contacting element is closely led around the circumference of the axis. The contacting element is pressed back into the neutral position by its own pre-tension.

For practical purposes, at least one lever arm is positioned approximately parallel to the circuit board in the direction of the terminal area when the handling element is closed. In order to mechanically secure the tension for a contacted flat conductor, this lever arm is advantageously fitted with a holding rod, the free end of which is positioned close to the circuit board when closed, or even penetrates the circuit board. This holding rod is designed to penetrate a contacted flat conductor when the handling element is closed, and thus to affix the conductor mechanically to the circuit board.

To prevent the contacting device from being opened unintentionally, the handling element is advantageously fitted with latching elements with which it can be fixed in the closed position. Here, the latching elements are designed in such a way as to enable the handling element to be unlatched without damage being caused.

In an advantageous further development of the contacting device, a supporting element is fitted to both longitudinal ends of the axis. The supporting elements enable the axis to be supported in such a way that it can be rotated on the one hand. Furthermore, the supporting elements preferably extend towards the terminal area, thus making it possible to guide the side of the flat conductor to be contacted. As a result, the flat conductor is forcibly aligned in such a way that in each case, one contacting element is positioned in the area of a conducting strip of the flat conductor.

For practical purposes, a guide channel is created for the flat conductor between each supporting element and the circuit board, in order to better guide the flat conductor. The supporting elements also act as a structurally simple counter flange for the latching elements of the handling element, in order to ensure that it latches into its closed position.

### BRIEF DESCRIPTION OF THE DRAWINGS

An exemplary embodiment of the invention is described in greater detail below relative to a drawing, in which:

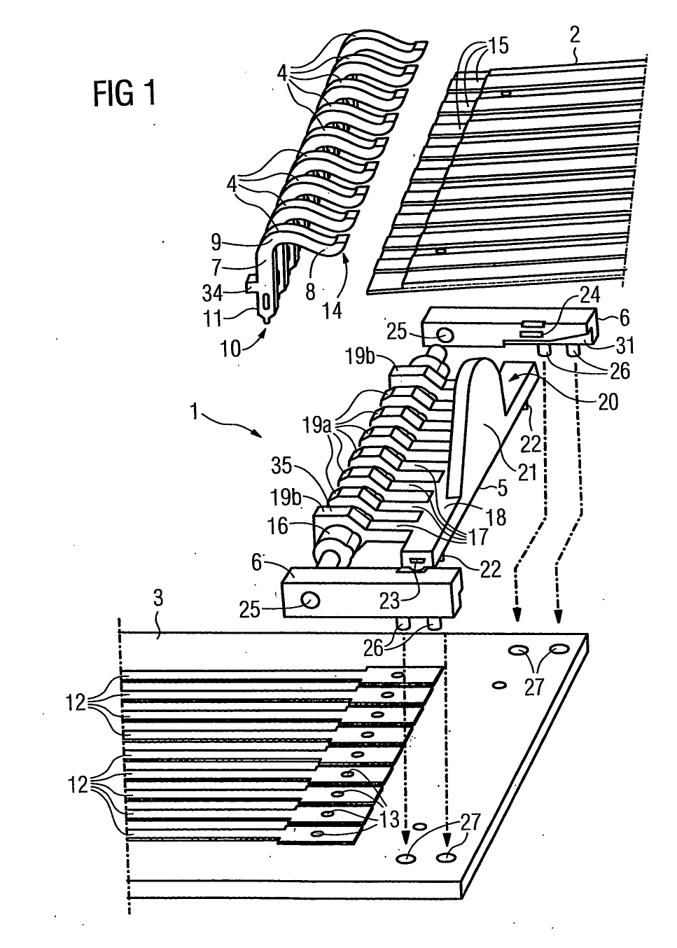

FIG. 1 shows an exploded view of a contacting device for contacting a flat conductor with a circuit board;

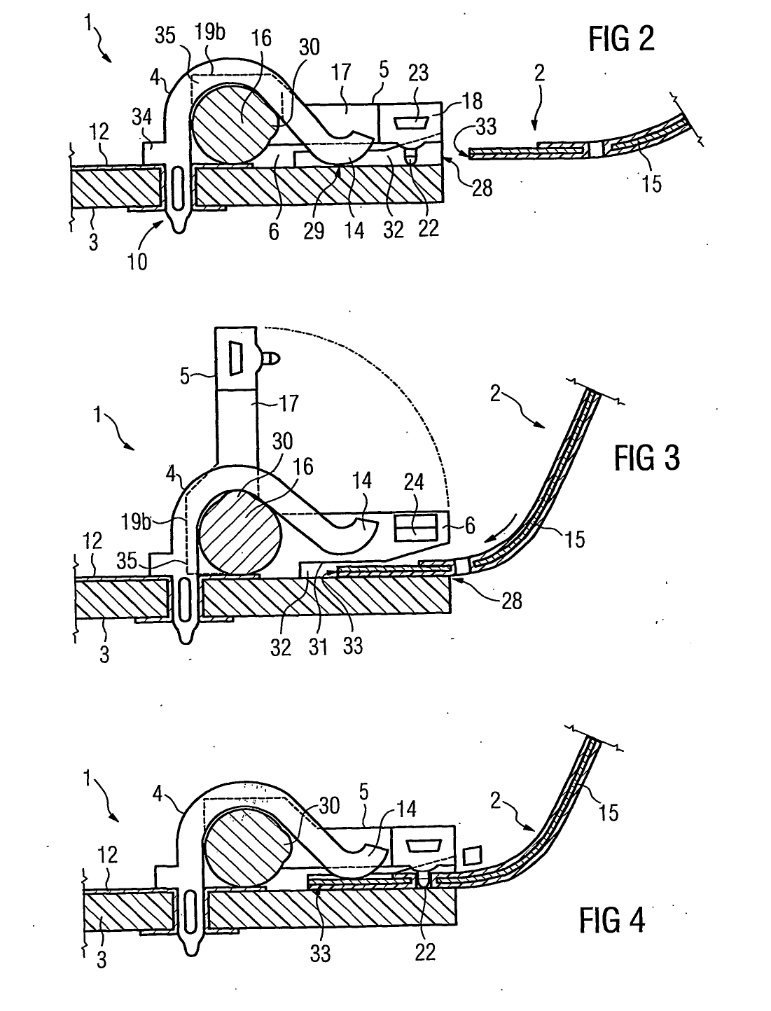

FIG. 2 shows a longitudinal cross-section of the closed contacting device before the flat conductor is inserted;

FIG. 3 shows the opened contacting device before the flat conductor is inserted;

FIG. 4 shows the closed contacting device when the flat conductor has been inserted and is contacted.

### DETAILED DESCRIPTION OF THE DRAWINGS

Parts which correspond to each other in the Figures are in all cases labelled with the same reference numerals.

FIG. 1 shows a contacting device 1 for contacting a flat conductor 2 with a circuit board 3. The contacting device 1 comprises in the stricter sense a number of contacting elements 4 (in the exemplary embodiment, nine), a handling element 5 and two supporting elements 6. Insofar as the circuit board 3 is positioned at close proximity in order to hold the contacting elements 4, the supporting elements 6 and the handling element 5 in a specific spatial arrangement to each other, the circuit board 3 can also be regarded in the wider sense as being a component of the contacting device 1.

The contacting element, or each contacting element 4 is generally a pressed part made of metal strips or a metal rod, and which is bent into a hook-like form. The contacting element 4 comprises an attachment flange 7 and a terminal flange 8 which are arranged at an acute angle to each other, and which are connected with each other via a bow segment 9. The free end of the attachment flange 7, designated hereafter as the attachment end 10, enables the contacting element 4 to be attached to the circuit board 3. For this purpose, the attachment end 10 is fitted with a slit contacting sword 11, which is designed to be pressed into a corresponding bore hole 13 which is arranged in the area of a conducting strip 12 on the circuit board 3. The attachment end 10 is also fitted with a limit stop 34 which stands out from the side of the attachment flange 7, and which limits the extent to which the attachment end can be pressed into the bore hole 13. The free end of the terminal flange 8, hereafter designated as the terminal end 14, is designed to contact a conducting strip 15 of the flat conductor 2. The contacting element 4 is bent in the area of the terminal end 14 against the direction of curvature of the bow segment 9, so that the contacting element 4 shows an “S” form when viewed from the side. The terminal end 14 therefore has a convex curve, in particular in relation to the circuit board 3.

The handling element 5 comprises an axis 16, from which lever arms 17 protrude in a radial direction at regular axial intervals. The lever arms 17 (which number eight in the exemplary embodiment) are oriented parallel to each other, and are connected at each of their ends facing away from the axis 16 by a shared cross-bar 18. The cross-bar 18 and the lever arms 17 thus create a comb-like structure. At the neck of each lever arm 17 on the axis 16, the axis 16 is broadened to create a disc-like shape, which is designated hereafter as the neck disc 19a, 19b. The inner neck discs 19a which run in an axial direction generally have an octagonal cross-section. Each of the two outer neck discs 19b which both run in the axial direction are the exception to this, with a modified octagonal cross-section form, the reverse upper quarter of which has the shape of a rectangular contour 35. The side of the handling element 5 which faces away from the cross-bar 18 is designated as being the “reverse side”. The side of the handling element 5 which faces away from the circuit board 3 when the closed handling element 5 is mounted on the circuit board 3 is designated as the “top side”. The cross-bar 18 is fitted on its top side 20 with a handle 21 which protrudes upwards. The opposite underside of the cross-bar 18 (not visible in FIG. 1) bears two holding rods 22 which protrude downwards. The cross-bar 18 is fitted on the front side, i.e. in the axial direction, with one latching catch 23, which corresponds to a latching retainer 24 on the neighbouring supporting element 6.

The supporting elements 6 are generally in the form of cuboid side walls, each of which has a bore hole 25 to enable the axis 16 to be supported in such a way that it can be rotated. Each supporting element 6 is fitted to an underside (not visible in FIG. 1) with two dowel-like projections 26, which can be pressed into corresponding retainers 27 in the circuit board 3.

When mounted, the end of the axis 16 is pushed in each case into the corresponding bore hole 25 of each adjacent supporting element 6. The support elements 6 are attached to the circuit board 3, the projections 26 having been pressed into the corresponding retainers 27. As a result, the axis 16 of the handling element 5 is supported parallel to the circuit board 3 and vertical to its conducting strips 12, in such a way that it can be rotated. Furthermore, the contacting elements 4 are pressed in each case with their attachment end 10 into each corresponding bore hole 11 of the circuit board 3, so that each contacting element 4 is attached by its attachment end 10 to the circuit board 3, and is electrically connected in each case with a corresponding conducting strip 12 on the circuit board 3. Each contacting element 4 encompasses the axis 16 in a clasp-like manner. The contacting elements 4 are arranged in an axial direction offset to the neck discs 19a, 19b, in such a way that each contacting element 4 (with the exception of the two external contacting elements 4) is recessed between two neck discs 19a, 19b.

This is shown in greater detail in a diagrammatic cross-section in FIG. 2 to FIG. 4. FIG. 2 shows the contacting device 1 for contacting the flat conductor 2. Here, the handling element 5 is in a closed position, in which the lever arms 17 are aligned approximately in parallel to the level of the circuit board 3, and point in the direction of an insertion end 28 for the flat conductor 2. When closed, the latching catches 23 are latched (in a manner not shown) to the corresponding latching retainer 24 of the supporting elements 6. When the handling element 5 is closed, the holding rods 22 are located close to the circuit board 3, or even penetrate it.

The closed position of the handling element 5 corresponds to a neutral position of the contacting element, or each contacting element 4. The contacting element 4 closely encompasses the circumference of the axis 16, i.e. it lies loosely on the circumference of the axis 16, or encompasses it at a close distance, while the terminal end 14 of the contacting element 4 is in contact with the circuit board under pre-tension. Here, the terminal area 29 in which the terminal end 14 is in contact with the circuit board 3 is specifically arranged between the axis 16 and the cross-bar 18 of the handling element 5. The contacting element 4 therefore grips through the comb tooth-like lever arms 17.

In order to guide the flat conductor 2 into the contacting device 1, the handling element 5 is released from the latch with the supporting elements 6 in accordance with FIG. 3. This can be achieved for example by splitting open the contacting elements 6 using a screwdriver. The handling element 5 is then swung over the axis 16 into an opened position, in which the lever arms 17 protrude vertically from the circuit board 3. Here, the rectangular contour 35 of the external neck disc 19b acts as a limit stop, which prevents the handling element 5 from being swung beyond its opened position. When the handling element 5 is being swung into its opened position, the contacting element, or each contacting element 4 is pulled out into an opened position, in which the terminal end 14 of the circuit board 3 is kept at a sufficient distance in order to be able to push the flat conductor 2 between the terminal end 14 and the circuit board 3 without applying pressure. In order to pull out the contacting elements 4, the axis 16 has an eccentric projection 30. This eccentric projection 30 is situated in approximately the same direction from the axis 16 as the lever arms 17, and is provided at least in the area of each contacting element 4.

In the closed position shown in FIG. 2 of the handling element 5, the eccentric projection 30 is not in any mechanical contact with the contacting element 4. This changes when the handling element 5 is swung from its closed position into its opened position. Here, the eccentric projection 30 is swung into the bearing area, i.e. the bow segment, in which the contacting element 4 closely encompasses the circumference of the axis 16. Here, the eccentric projection 30 impacts the contacting element or each contacting element 4, and bends it into its opened position. The flat conductor 2 can now be pushed into the insertion end 28 of the contacting device 1.

The supporting elements 6 are used as a guide on the side of the flat conductor 2, which ensures that the conducting strips 15 of the flat conductor 2 are positioned correctly in relation to the contacting elements 4. In order to achieve a stable hold for the flat conductor 2 in the contacting device 1, specifically to prevent the flat conductor 2 from being twisted in the contact area, the supporting elements 6 are fitted on the side facing the circuit board 3 with a guide contour 31, which together with the adjacent circuit board 3 forms a guide channel 32 for the flat conductor 2. In the guide channels 32 which face each other, the edges of the flat conductor 2 are enclosed on three sides, which enables the flat conductor 2 to be aligned precisely, and which also prevents twisting.

The flat conductor 2 is pushed forward with a contact end 33 (im deutschen Text 32) into the insertion end 28 of the contacting device 1. On the contact end 33, the flat conductor 2 is de-insulated on at least one side, so that its conducting strips 15 are bared on at least the side facing away from the circuit board 3. The contacting device 1 is aligned with the flat conductor 2 to be contacted in such a way that a contacting element 4 is arranged at the axial height of each conducting strip 15.

This now enables the flat conductor 2 to be contacted after it has been pushed in. For this purpose, the handling element 5 in accordance with FIG. 4 is swung back into its closed position and latched with the supporting elements 6. Here, the holding rods 22 penetrate the flat conductor 2 and thus affix it mechanically to the circuit board 3. When the handling element 5 is lowered back into its closed position, the eccentric projection 30 is in turn swung out of the bearing area with the contacting elements 4. The contacting elements 4 return to the neutral position due to their inherent elasticity. The contact end 33 of the flat conductor 2 is thus jammed between the terminal end 14 of the contacting element 4 and the circuit board 3. Here, the terminal end 14 of a contacting element is positioned over the insulated end section of a corresponding conducting strip 15 of the flat conductor 2. The conducting strip 15 of the flat conductor 2 is thus short-circuited via the contacting element 4 with a corresponding conducting strip 12 of the circuit board 3.

The connection between the flat conductor 2 and the circuit board 3 can be detached without causing damage by swinging the handling element back into its opened position in accordance with FIG. 3. The flat conductor 2 can then be removed without applying force.

### LIST OF REFERENCE NUMERALS

1 Contacting device
2 Flat conductor
3 Circuit board
4 Contacting element
5 Handling element
6 Supporting element
7 Attachment flange
8 Terminal flange
9 Bow segment
10 Attachment end
11 Contacting sword
12 Conducting strip
13 Bore hole
14 Terminal end
15 Conducting strip
16 Axis
17 Lever arm
18 Cross-bar
19a, 19b Neck disc
20 Top side
21 Handle
22 Holding rod
23 Latching catch
24 Latching retainer
25 Bore hole
26 Projection
27 Retainer
28 Insertion end
29 Terminal area
30 Eccentric projection
31 Guide contour
32 Guide channel
33 Contact end
34 Limit stop
35 Rectangular contour

1-14. (canceled)

15. A contacting device (1) for contacting a flexible flat conductor (2) to a circuit board (3), the device comprising:
at least one contacting element (4), which is attached with an attachment end (10) to the circuit board (3) and which is in contact with a terminal end (14) in a neutral position and under pre-tension with the circuit board (3); and
a handling element (5), which can be used to reversibly pull out the terminal end (14) of the contacting element, or each contacting element (4) from the neutral position into the opened position, in which the terminal end, or each terminal end (14) is positioned at a sufficient distance from the circuit board (3) to enable the flat conductor (2) to be inserted without applying pressure.
a modular plug group (3, 4) assembled from two or more individual plugs (1, 2, 10, 11, 12, 31-34); wherein the socket is configured so that the individual plugs in the modular plug group that are inserted into the plug housing (15) form a plug group comprising at least two individual plugs (1, 2, 10, 11, 12, 31-34) arranged in a row.

16. The contacting device to claim 15, wherein the attachment end (10) of the contacting element, or each contacting element (4) is pressed into the circuit board (3).

17. The contacting device according to claim 15, wherein several contacting elements (4), the terminal ends (14) of which can be simultaneously pulled out using the handling element (5).

18. The contacting device according to claim 15, wherein the contacting element (4) is in the form of a strip or rod having a hook-like bent shape.

19. The contacting device according to claim 15, wherein the handling element (5) includes an axis (16) in parallel to the circuit board (3) which can be rotated, and at least one lever arm (17) which protrudes approximately in a radial direction from the axis (16).

20. The contacting device according to claim 19, wherein a bow segment (9) of the contacting element, or each contacting element (4) is closely led around the circumference of the axis (16).

21. The contacting device according to claim 19 wherein the handling element (5) can be reversibly swung around the axis (16) from a closed position into an opened position, and that the axis (16) comprises an eccentric projection (30) in at least the area of each contacting element (4), which impacts the contacting element (4) in the opened position while being pulled out, and which is swung out in the closed position from the bearing area between the contacting element (4) and the axis (16).

22. The contacting device according to claim 19, wherein at least one lever arm (17) of the handling element (5) comprises a holding rod (22) to secure tension for the flat conductor (2), and the holding rod (22) being positioned closely to the circuit board (3) when in closed position.

23. The contacting device according to claim 15 further comprising latching elements (23, 24), which can be used to affix the handling element (5) in the closed position.

24. The contacting device according to claim 15 further comprising side supporting elements (6), between which the axis (16) is supported in such a way that it can be rotated.

25. The contacting device according to claim 24, wherein the supporting elements (6) are designed to guide the sides of the flat conductor (2).

26. The contacting device according to claim 25, between each supporting element (6) and the circuit board (3), a guide channel (32) is designed for the flat conductor (2).

27. The contacting device according to claim 24, wherein the handling element (5) is latched in closed position to the supporting element (6).

28. The contacting device according to claim 24, wherein the terminal end (14) has a convex curve in relation to the circuit board (3).
